(19) United States
(12) Patent Application Publication
(10) Pub. No.: US 2025/0326177 A1
(43) Pub. Date: Oct. 23, 2025

(54) CELLULOSE CONTAINER AND METHOD OF FABRICATING

(71) Applicant: NORTH AMERICA I.M.L. CONTAINERS INC., St-Placide (CA)

(72) Inventor: Nicolas BOUVERET, St-Placide (CA)

(21) Appl. No.: 19/186,793

(22) Filed: Apr. 23, 2025

Related U.S. Application Data
(60) Provisional application No. 63/637,594, filed on Apr. 23, 2024.

(51) Int. Cl. B29C 51/00; B29C 51/02; B29C 51/26; B29C 51/44; B29K 1/00; B29L 31/00; B65D 1/26; B65D 25/14

(52) U.S. Cl. CPC B29C 51/002; B29C 51/006; B29C 51/02; B29C 51/264; B29C 51/44; B65D 1/26; B65D 25/14; B29K 2001/00; B29L 2031/712

(57) ABSTRACT

A container or lid comprising: a body of molded cellulose, the body of molded cellulose defining at least one wall, the wall having an outer surface and an inner surface. The container or lid has is made of blown cellulose fibers from a mat compressed in at least one compression step. A method for forming a container or lid having a cellulose body may also be provided.

### CROSS-REFERENCE TO RELATED APPLICATION

The present application claims the priority of U.S. Patent Application No. 63/637,594, filed on Apr. 23, 2024, and incorporated herein by reference.

### TECHNICAL FIELD

The application relates to cellulose containers used in the packaging industry for products such as foodstuff, cosmetics, or objects or materials of various types. The cellulose may also be referred to as moulded (molded) pulp, fiber (fibre), thermoformed fiber (fibre), optionally in the context of dry molding.

### BACKGROUND

Containers are traditionally used when packaging foodstuff in liquid or loose form, or for other objects, or materials. While plastics have been commonly used due to their properties, there remains a demand for the use of molded cellulose for containers. There are various reasons for the popularity of cellulose for containers, notably the use of natural fibers for such containers, the compostable nature of some of these cellulose containers, the possibility of using recycled fibers, the cost-effectiveness, and the sustainability, to name a few advantages.

However, in contrast to plastics that have a molten state and can conform to the shape of a mold, the cellulose used for containers may not as easily be shaped. Typically, mats or sheets of cellulose may be thermoformed but the lack of elasticity may be a constraint to achieving given shapes, including adding depth to cellulose-based containers. Accordingly, the manufacturing techniques for cellulose-based containers and recipients may resort to having joints or seams to have deeper shapes. Joints or seams may require the use of adhesives, additional steps during manufacturing, and may nevertheless be exposed to leakage at such joints.

Moreover, due to the constraints in manufacturing, cellulose fibers that are used must often undergo various steps of refinement, to enable them to be used in containers. For example, in the case of cellulose fibers from a tree, according to some uses, up to 50% of the constituents of the cellulose fibers could be removed through mechanical and/or chemical processes for the cellulose fibers to be usable.

It would be desirable to facilitate the manufacturing of cellulose-based containers.

### SUMMARY

In a first aspect, there is provided a container or lid comprising: a body of molded cellulose, the body of molded cellulose defining at least one wall, the wall having an outer surface and an inner surface, wherein the container or lid has is made of blown cellulose fibers from a mat compressed in at least one compression step.

Further in accordance with the first aspect, for example, the container or lid is seamless and/or jointless.

Still further in accordance with the first aspect, for example, the at least one wall has a thickness of 0.3 mm to 0.6 mm inclusively.

Still further in accordance with the first aspect, for example, the body defines an inner cavity.

Still further in accordance with the first aspect, for example, a surface of the inner cavity has a coating thereon.

Still further in accordance with the first aspect, for example, the coating is a waterproofing coating.

Still further in accordance with the first aspect, for example, the at least one wall has at least two layers of the blown cellulose fibers.

Still further in accordance with the first aspect, for example, one of the at least two layers is a hydrophobic layer.

Still further in accordance with the first aspect, for example, the hydrophobic layer defines an interior surface of the container or lid.

Still further in accordance with the first aspect, for example, one of the at least two layers is a lipophobic layer.

Still further in accordance with the first aspect, for example, the lipophobic layer defines an exterior surface of the container or lid.

In a second aspect, there is provided a method for forming a container having a cellulose body comprising: blowing cellulose fibers onto a surface of a mold to form a layer of cellulose fibers into the surface of the mold; pressing the layer of cellulose fibers in the mold, whereby the cellulose is thermoformed into a monoblock piece of interconnected cellulose fibers; and removing the monoblock piece of interconnected cellulose fibers.

Further in accordance with the second aspect, for example, the cellulose fibers are softwood fibers.

Still further in accordance with the second aspect, for example, the cellulose fibers have a length between 2.5-3.5 mm, inclusively.

Still further in accordance with the second aspect, for example, pressing the layer of cellulose fibers includes heating the layer of cellulose fibers.

Still further in accordance with the second aspect, for example, blowing cellulose fibers onto the surface of the mold to form the layer including forming the layer having a thickness of 4-6 mm.

Still further in accordance with the second aspect, for example, pressing the layer of cellulose fibers into the monoblock includes pressing the layer of cellulose fivers into the monoblock having a thickness between 1-3 mm.

Still further in accordance with the second aspect, for example, the method may include repeating the pressuring and the removing with another mold, using the monoblock piece.

Still further in accordance with the second aspect, for example, the method may include shredding raw material into the cellulose fibers.

Still further in accordance with the second aspect, for example, the method may include humidifying the raw material prior to the shredding.

### DESCRIPTION OF THE DRAWINGS

Reference is now made to the accompanying figures in which:

FIG. 1 is a perspective view of a cellulose container and lid from seamless thermoforming in accordance with the present disclosure;

FIG. 2 is a schematic view showing a manufacturing of a 3D mat for seamless thermoforming;

FIG. 3 is a schematic view of a movement of nozzles relative to a mold upon which the 3D mat is formed; and

FIGS. 4A to 4C show an exemplary mold used to fabricate the 3D mat used to form the cellulose container of the present disclosure.

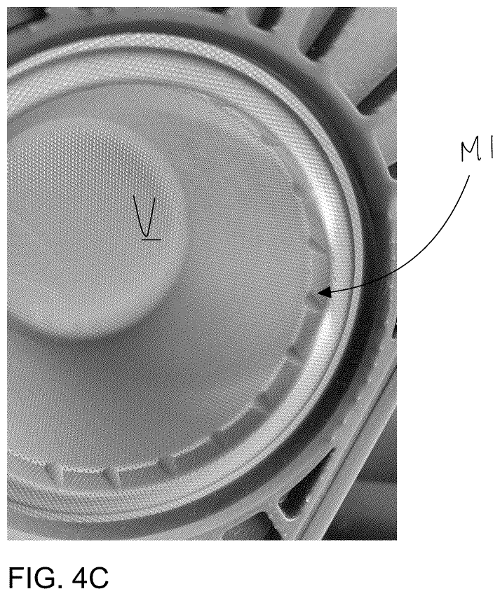

### DETAILED DESCRIPTION

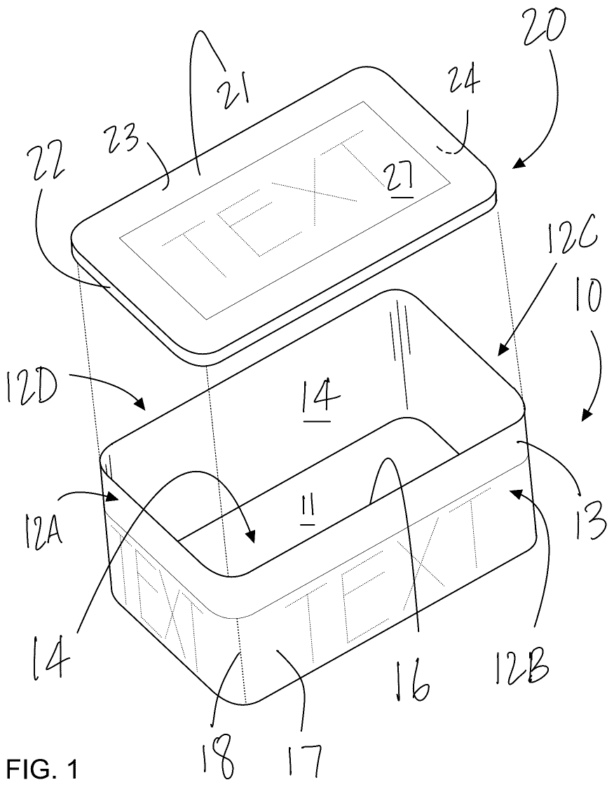

Referring to the drawings and more particularly to FIG. 1, a cellulose container in accordance with the present disclosure is generally shown at 10. The container 10 may be referred to as a receptacle, a cup, a pot, a package, among other possible names. Moreover, while a container is shown, other objects may be made of cellulose in accordance with the present disclosure, such as cups, trays, bowls, among examples. As shown in FIG. 1, the container 10 may be used with a lid 20 that may be releasably secured to a top of the container 10 to close a top opened end of the container 10. The lid 20 may or may not be made of cellulose, but in the illustrated embodiment, it is. Likewise, the container 10 may not be made of cellulose, while the lid 20 is. Stated differently, the present disclosure pertains to a container 10 made of cellulose, and/or a lid 20 made of cellulose. The container 10 may be used for packaging various items, whether in liquid, solid, gel, viscous forms, or as loose material or matter, granules, etc. The lid 20 may be used to close the open top of a container, such as the container 10.

The container 10 has cellulose as a main material. The cellulose is said to be the main material in that it makes up the greatest proportion by weight and/or by volume of the empty container 10. The cellulose may also be said to form the structure of the container 10, in that the shape of the container 10 is provided and maintained by the cellulose. Cellulose may also be known as moulded (molded) pulp, fiber (fibre), thermoformed fiber (fibre). These expressions may be used interchangeably herein. The cellulose may have any appropriate natural fibers (biomass) such as wood fibers, plant fibers, straw, cereals, annual plants, etc. The moulded cellulose may be made from recycled paper and water, cardboard, virgin cellulose. Additives can be added to the pulp to give desired characteristics to the cellulose. The given characteristics may include colour, moisture resistance, oil resistance and/or enhanced shock resistance. In a variant, the process set out herein for the manufacturing of the container 10 or lid 20 allows the use of cellulose fiber that may contain up to 80% by weight of the constituents of cellulose fiber from a tree. In a variant, the fibers are softwood fibers, such as pine wood fibers (a.k.a., pine fibers). For example, in the process described below to manufacture the container 10 and/or lid 20, the use of fibers having a range of length from 2.5 mm to 3.5 mm, inclusively, may contribute to an enhanced structural integrity of the walls of the container 10 and/or lid 20. However, this range is merely given as an example, as the fibers may be shorter or longer, though there may be greater structural integrity with longer cellulose fibers. In a variant, the fibers may be CTMP fibers (chemi-thermo mechanical pulp fibers). Stated different, the process enables the use of cellulose fibers that have had limited treatment after being fiberized from a tree, or from sheets of carboard, paper, etc. Moreover, the cellulose may be said to be dry cellulose fiber, and the various steps for forming a container or object with the cellulose fiber may be referred to as dry molding. Some water may be injected in the process to reduce volatility of the dry cellulose fiber, but the humidity content may be at most 15% per weight of water to cellulose fiber. In a variant, the humidity content is between 5 and 15%, inclusively, such that the process remains known as dry molding.

The container 10 shown in FIG. 1 has a generally rectangular prism shape with top opened end (e.g., slight upward flaring for mold ejection), when seen from a top view, but any other appropriate shape may be used with other possible geometries. The shapes may include oblong (as shown), rectangular, square, polygonal, oval, circular, among possible peripheral shapes, with the possibility of shape transitions (e.g., from a rectangular base to an oval rim). Geometries may include prisms, cylinders, hemispheres, truncated hemispheres, truncated cones, cones, boxes, combinations thereof, among possible geometries. The container 10 may not be limited to any particular shape.

Reference will now be made to the container 10 when laid on a horizontal surface and thus with its open top end. In such an orientation, the container 10 may be said to have a bottom wall 11 with side walls 12 projecting generally upwardly (e.g., perpendicular to the bottom wall 11, or at other angles relative to the bottom wall 11). There are four different side walls 12 shown based on the exemplary geometry, namely side walls 12A, 12B, 12C and 12D. The side walls are referred to concurrently as 12 in the description but are shown as 12A-12D in the figures. Although sharp edges are shown between the bottom wall 11 and the side walls 12, a continuous geometry may be used to avoid the presence of sharp edges. For example, a bowl-shaped hemisphere may not have such sharp edges. Likewise, the side walls 12A to 12D may be said to be distinct from one another as each forms a side of the container 10, but the container 10 may be construed as having a single side wall 12 forming a closed figure with itself, for instance when the container 10 has a cylindrical shape, or corner regions may be arcuate so as to optionally have an inner surface and/or an outer surface without apparent edges. For simplicity, reference is made to the container 10 as having side walls 12, but the present disclosure also covers a single side wall 12 as described above.

The bottom wall 11 and the side walls 12 are part of a body of molded cellulose. The body may be said to be monoblock in that the bottom wall 11 and the side walls 12 are integrally molded together as one piece (though the walls 11 may have labels as described herein). The bottom wall 11 and side walls 12 concurrently define an outer exposed surface 13 of the container 10. More specifically, when the container 10 has the lid 20 thereon, the part of the container 10 that is seen is the outer exposed surface 13. The bottom wall 11 and side walls 12 also concurrently define an inner surface 14 that may also be referred to as inner surfaces 14. As detailed below, the inner surface 14 may not necessarily be of cellulose as it is contemplated to provide some surface coatings to provide given characteristics to the container 10, such as waterproofness or airtightness. The surface coatings, surface sizing may be added after molding, for example.

The combination of the bottom wall 11 and the side walls 12 define a concavity 15. The concavity 15 may be referred to as the inner cavity 15 of the container 10. It is the inner cavity 15 that acts as a receptacle for receiving material in the container 10. The volume of the inner cavity 14 may depend on the contemplated use. While the inner cavity 15 is shown as defined by the continuous, smooth surfaces of the bottom wall 11 and side walls 12, it is considered to provide the container 10 with various surface features, to define compartments, supports. For example, if the container 10 is used as an egg box, there may be a half dozen or a dozen interior support features to hold up the eggs separately.

A rim 16 defines the top open end of the container 10 and is at a junction between the outer exposed surface 13 and the inner surface 14. The rim 16 is shown as being a single continuous linear edge that may lie in a flat plane. However, it is considered to have features such as flanges, catches, ledges, wedges, holes, bosses, channels, to form part of connection features to releasably secure the lid 20 to the container 10, for instance by complementary connection features on the lid 20. In a variant, the rim 16 may define a flange or like surface for a sealing operculum (e.g., plastic film) to be sealingly secured to the container 10.

One or more labels 17 may optionally be provided on the outer exposed surface 13. The label(s) 17 is provided to identify the product in the container 10, for example, and may have information such as a brand, drawings, logos, pictures, names, volume data, nutritional data, service information, barcode, QR code, to name but a few of the types of data that may be on the label(s) 17. The label(s) 17 may have a paper substrate or facestock, upon which data is printed, drawn, etc. Additional layers may be provided on the label(s) 17, though the surface of the label(s) 17 interfaced to the cellulose of the container 10 is fiber-based, such as paper. The label 17 may also be made of a polymer substrate. However, the use of a fiber-based material for the label 17 may facilitate disposal of the container 10 with label 17, such as through composting or recycling.

As shown in FIG. 1, a single label 17 covers side walls 12A and 12B. It is also considered to have that single label 17 cover the side walls 12C and 12D and/or the bottom wall 11 as well, with the single label 17 folded at the intersection between walls 11 and 12, if necessary. Moreover, the label 17, as a single sheet of paper, may be die cut into a given shape, to be folded and/or formed to the shape of the container 10. As a result, a seam 18 may be present in the label 17. Other label configurations are considered, such as having discrete labels 17 on separate faces of the container 10.

The container 10 may be used without a lid 20, or may have a cover that is sealed to the rim 16. For example, the cover may be a sealed polymer (e.g., a transparent plastic film), a sheet of aluminum, composites, etc.

The container 10 may be said to be seamless, as there may not be any joint between adjacent side walls, such as joints between side walls 12A-12B-12C-12D. Stated differently, no glue, no overlap, no butting may be present in the container 10. In variant, the container 10 may be said to be seamless because of the absence of any joint formed at or after thermoforming of the container 10. Some of the constituents of the container 10 may have had joints, but the container 10 may be in the form of a three-dimensional (3D) mat before thermoforming, such that from the condition as a 3D mat to the condition of the container 10 as a final product (e.g., as in FIG. 1), no joint is formed.

While the container 10 is shown and described as being seamless, a lid 20 may also be manufactured in a similar manner, and may also be seamless cellulose. The lid 20 may be in addition to any cover sealed to the container 10, as described above. Still referring to FIG. 1, the lid 20 is shown as being generally flat. The lid 20 may have a cover wall 21 that is shaped to be laid onto the container 10 so as to close the open top end of the container 10. Consequently, the cover wall 21 may be said to be planar or flat, but may have other geometries as well (e.g., three dimensional shapes, such as a dome, as alternatives to the being flat. Likewise, the contour of the cover wall 21 generally matches the shape of the open top end of the container 10, but may have other shapes based on the shape of the container 10.

According to an embodiment, the lid 20 has a skirt 22 by which it attaches to the rim 16 of the container 10. The skirt 22 may also be referred to as a peripheral wall, as a catch, as a ledge, and may use any appropriate connection technology for the releasable complementary connection to the container 10. The lid 20 has an outer exposed surface 23 that may also be referred to as a main surface of the lid 20 and that is seen when the container 10 is closed with the lid 20. The outer exposed surface 23 is generally flat but may have surface features, for instance to enable the stacking of filled containers with lids 20 thereon, such as ribs, shoulders, etc. The inner surface 24 is on an opposite surface of the outer exposed surface 23. The inner surface 24 typically faces the inner cavity 15. The inner surface 24 may have a surface coating that may be equivalent to the surface coating that is on the inner surface 14 of the container 10. In similar fashion to the container 10, a label 27 may be provided on the outer exposed surface 23 of the lid 20, though optionally. The lid 20 may also be made of a material other than molded cellulose.

The walls 11, 12 and/or 21 may be made of a single layer of cellulosic material, but more than one layer may be present. For example, an outer layer and/or a central layer, defining the outer exposed surface 13/23, may be made of recycled fibers, while an inner layer, i.e., that may be in touch with foodstuff depending on use, may be made of virgin fibers. As another example, an outer layer may include a first color and the inner layer may include a second color. As yet another example, the layers may have different fiber orientations, to strengthen the end container.

A coating(s) may cover (a.k.a., surface sizing) the inner surface 14/24 of the container 10/lid 20. The coating may be applied after the molding of the container 10 or lid 20. The coating may be any appropriate type of coating to provide some characteristics to the container 10 or lid 20, as described above. For example, the coating may be a wax, a polymer, an oil, and as a result properties such as airtightness, waterproofness, may be given to the container 10/lid 20. Additional coating layers may be provided, for instance on top of the coating, or on the outer exposed surface 13/23.

In an embodiment, no added adhesive is between the labels 17/27 (e.g., they are adhesive-less) and the cellulose of the walls 11, 12, 21, but starch that is an integral part of the pulp in the molding process may contribute to the adhesion of the paper substrate of the label 17/27 to the cellulose of the walls 11/12/21. In another embodiment, a thin layer or spots of a dry liquid-activated adhesive (moistenable adhesive) is provided on the surface of the label 17/27 that adheres to the walls 11/12/21. A dry liquid-activated adhesive may be said to have limited tackiness when dry, but with the tackiness increasing substantially once the adhesive is moistened. The liquid-activated adhesive may for instance be a dextrin (e.g., vegetable starch). In another embodiment, the pulp sludge may incorporate an adhesive additive.

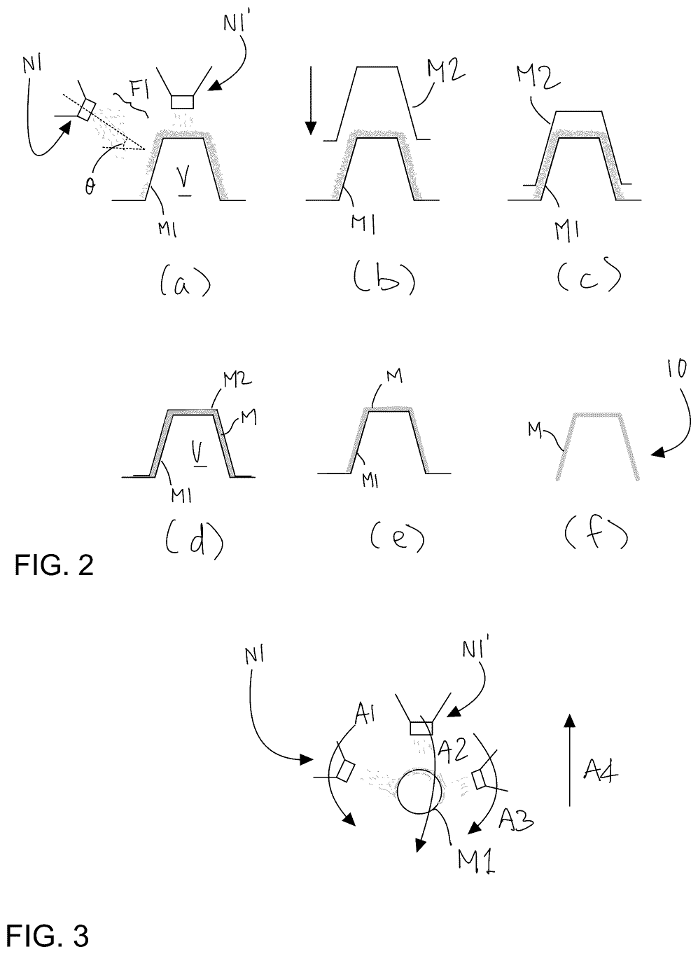

In order to thermoform the container 10 and/or the lid 20, a 3D mat M is required. The 3D mat M may fabricated according to any suitable manufacturing method, including one described with reference to FIG. 2. The 3D mat M may be made from various types of cellulose fibers, including cellulose fibers with limited transformation after being fiberized from a tree (e.g., at least 80% by weight of the constituents from a tree), from boards, from cardboard, from sheets, or other fibers, including an airlaid fluff material. In a variant, the fibers F1 are softwood fibers, and may have a length ranging from 1.0 mm to 3.0 mm, inclusively, with a particular range of 2.5 mm to 3.5 mm, inclusively, being well suited for the walls of the container 10 and/or lid 20. Airlaid fluff material is a textile-like material made of fibers of cellulose, also referred to as fluff pulp. The fibers may be consolidated with mechanical, chemical or thermal energy to form a nonwoven fabric. The airlaid fluff material may be a porous and soft material, yet stronger than standard paper, even when wet. Other materials may be used.

In a variant, the 3D mat may include a porous 3D mold M1, i.e., it has air permeablility. FIGS. 5A-5C show an exemplary configuration of such a 3D mold M1, with pores that are sized to be smaller than the cellulose fibers, for the cellulose fibers F1 to gather on the surface of the 3D mold M1 as in FIG. 2 (a). The mold M1 may be fabricated according to any appropriate process, and is given a 3D shape that emulates more or less the contemplated shape of the container 10, lid 20, or other end product. In a variant, it is considered to provide a mesh that can serve as a substrate for the fibers F1, though this is optional. Such substrate may not have substantial structural integrity in and of itself. The mold M1 of FIG. 2(a) may be part of a conveyor line with a plurality of other such molds M1.

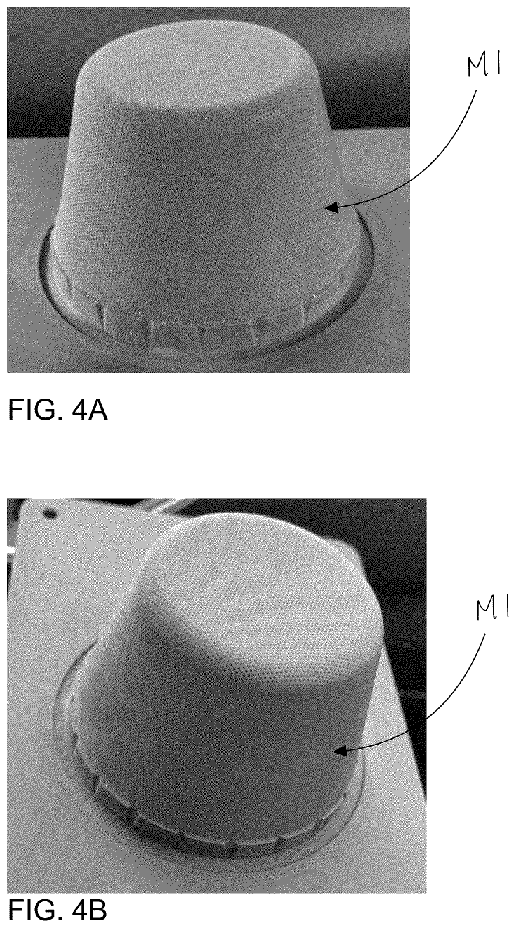

Still according to FIG. 2(a), cellulose fibers F1 may be conveyed by an air stream out of a nozzle N1, and onto the outer surface of the mold M1. In a variant, the spraying occurs in a closed chamber. It is also possible to exert a vacuum V in an inner cavity of the mold M1, for the fibers F1 to be drawn to and to accumulate on the outer surface of the mold M1. While the mold M1 is shown receiving the fibers F1 on its outer convex surface, the reverse arrangement than the one shown in FIG. 2(a) may also be achieved. Stated differently, in FIG. 2(a), it is shown that the cellulose fibers F1 are projected onto the outer surface of the mold M1, but the inner surface of the mold M1 may also be coated. Relative movement may be induced between the nozzle N and the mold M1, for the stream of cellulose fibers F1 to cover all desired surfaces of the mold M1. For example, as shown in FIG. 3, a possible movement of a system of nozzles N1 relative to a mold M1 is shown, with arrows A1 and A3 showing a circular movement about a generally vertical axis, while arrow A2 shows a circular movement about a horizontal axis (transverse to movement A4 of the mold M1). Movement A4 may be the result of the conveyor movement of the mold M1, and/or that of the nozzle N1 moving along A2. The nozzles N1 that move along A1 and A3 may be angled at an angle θ (e.g., between 35 and 75 degrees) relative to a direction of movement to a horizontal plane, while the nozzle N1 moving along arrow A2 may be vertical (e.g., as in FIG. 2(a), shown as N1′). FIG. 2 may be equivalent to a sintering process. The cellulose fibers F1 may accumulate on the surface of the mold M1 because of the porous surface of the mold M1 and optional vacuum assistance V, which may allow accumulation of the fibers F1 thereon. Other arrangements are considered, include electrostatic forces, humidity, etc. In a variant, there may be more than one pass in the pulverizing step of FIG. 2(a). For example, a first layer may be accumulated, with a first property (e.g., a waterproofing, hydrophobicity), such as 50 g/m²±10 g/m², inclusively. In a variant, the first layer is a generally waterproof or water resistant layer, and forms the interior of the container 10 and/or lid 20. The fibers pulverized onto the mold M1 to form the first layer may have an additive to give it the given properties, such as polypropylene or polyethylene beads, or a alkyl ketene dimer emulsion for hydrophobic properties. Another layer may then be added, such as a thicker, structure layer, without additives, or with other additives. For example, a second layer is thicker and stronger, 500 g/m²±100 g/m², inclusively. In an optional variant, a third layer is then added, and would form the outer layer of the container 10 and/or lid 20. In a variant, the third layer would have distinct properties, such as oil resistance, lipophobia. An additive for this property may be fatty acids, added to the fluff pulp for example, to the point of saturation. The third layer may be thinner and lighter than the second layer, such as 50 g/m²±10 g/m², inclusively. These values are given as an example only.

Again, the cellulose fibers F1 may be near raw wood fibers, fluff pulp, or any other form of cellulose fibers, that may have been fiberized from any appropriate format (e.g., chips, roll). In a variant, the process includes the step of generating the fluff material, from a structure such as planks, sheets, boards, etc. For example, the cellulose may come in the form of carboard, and may be shred to the appropriate sized for the subsequent pulverizing of FIG. 2(a). Itis contemplated to humidify the raw material ahead of the shredding, to limit the generation of airborne particles and/or dust. Moreover, additives may be added ahead of the shredding. For example, fibers in the raw material (e.g., cardboard) or fiberized may be saturated by the additive, to then be dried, prior to being pulverized/blown onto the mold M1. A hammermill may be used for the fiberizing, such that the cellulose fibers F1 may even reach nanocellulose state. The cellulose fibers F1 may be fed to an air stream to be blown onto the mold M1 by the nozzle(s) N1. In a variant, some additives may be added to the airstream and/or to the fibers. For example, hydrophobic and/or lipophobic additives may be added and/or mixed to the cellulose fibers F1, for the cellulose fibers F1 to have such properties, as described above. Because of the process step shown in FIG. 2(a), the 3D mat may be said to be seamless. In some instances, the cellulose fibers F1 cover any seam in a substrate, if present. The thickness of the layer of fibers F1 may be between 4 to 6 mm in a variant, though it could be outside this range.

In FIG. 2(b) and FIG. 2(c), it is shown that a complementary mold M2 may be matingly engaged with the mold M1, to solidify the layer of fibers F1. The molds M1 and/or M2 may also be heated such that the optional combination of heat and pressure solidifies the layer of fibers F1 into a monoblock mat M, that holds together, notably by the non-woven intermingling of the fibers F1, and/or a scratching effect between the fibers F1 Indeed, the geometry, inherent frictional forces and other properties of the fibers F1 allow them to connect and form that mat M shown in FIGS. 2(d), 2(e) and 2(f). After removal of either one of the molds M1 and M2, the mat M may be removed as a whole, with the fibers F1 holding up into a monoblock piece. In a variant, the mat M resulting from a first compression sequence as in FIGS. 2(b) to 2(e) has a thickness between 1 to 3 mm. If numerous layers are present (i.e., more than one), the multiple layers may be added one onto the other as in FIG. 2(a), for the multiple layers to then be compressed as in FIG. 2(b). Alternatively, it is possible to repeat the steps of FIGS. 2(a) to 2(e) for each layer.

In a variant, the mat M of FIG. 2(f) may optionally undergo at least one more compression sequence, thus repeating the steps illustrated in FIGS. 2(b) to 2(e). In this subsequent sequence of compression, the mold M1 and/or the mold M2 may have a different geometry than that used in the first sequence of compression. Moreover, the parameters of the compression, e.g., the pressure and the heat, may differ from that of the first sequence of compression. In an embodiment, the variation is used to ensure that the mat M has a relatively uniform thickness. The humidity content of the mat M may reduce in the steps illustrated in FIGS. 2(a) to 2(e), due to exposure to air, to heat, to pressure.

After the compression, the mat M has been formed into the container 10, lid 20, or other receptacle or component used in foodtstuff packaging. In a variant, the thickness after this (these) additional compression sequence(s) is between 0.3 to 0.6 mm, and more particularly between 0.4-0.5 mm.

As variants, it is also considered to provide inflatable bladders to exert a compressive action, as an alternative to molds M1 and/or M2. For example, the mold M1 and M2 exert a pressure when closing, but in a direction of closure. Bladders may be present to exert a pressure in another direction, such as transverse to the mold closing direction.

As shown in FIGS. 2(b)-2(d), the first mold part M1 is separated from the second mold part M2. When the mold part M2 is pressed against the mold part M1 in the manner shown in FIG. 2(d), there results a cavity that has the geometry of the part to be molded, that is the geometry of the container 10, or close to that of the container 10, depending on the number of compression sequences. The insertion of the 3D mat M may be done manually, by a robot, etc, after the first compression sequence. The cellulose mat M may be a preformed version of the container 10, that may generally have the shape of the container 10, though thicker. For example, the cellulose mat M may be an individual piece manipulated by robot. The cellulose mat M may be dry, or may have a level of dampness.

The compression may cause a reduction in wall thickness, up to 3 or 4 times, if not more. For example, the walls 11, 12, 21 may have a thickness of 0.3 mm to 0.6 mm (inclusively), while the cellulose mat M may have had a thickness between 1.0 and 3.0 mm (if not more). There also results an increase in density in the process. Heating also occurs to contribute to the shaping of the fibers and to the evacuation of water from the cellulose and from the mold, if any humidity is present. The process may be said to be dry, as no humidity may be added.

This may be part of a thermoforming process for molded cellulose and/or may be known as a “dry molding”, as no substantial amount of water is added to the cellulose, i.e., the humidity level may not exceed 15% per weight. Moreover, the cellulose may remain mostly dry in some if not all of the steps starting with FIG. 2(a). The thermoforming process/dry molding is well suited to use a multi-layer cellulose body, i.e., with the label 17. The pulp may also include starch that contributes to the adhesion of the paper of the label 17 to the cellulose. If the label 17 has a dry liquid-activated adhesive, the moisture in the pulp and the pressure in the mold ensure that the label 17 bonds to the cellulose of the wall 21. As the combination of the label 17 and cellulose of the container 10 are dried, the label 17 becomes an integral part of the container 10, that defines the depression as a result of the label 17 being in the mold. There may result a continuous edgeless surface. Once the container 10/lid 20 is ejected from the mold, a surface coating A may be applied. For example, a surface coating may be applied to the inner surfaces 14 and/or 24 to provide it (them) with properties, such as water-resistance or waterproofness. A lamination of a layer may be done, such as lamination of a plastic layer. This is optional.

In an embodiment, the process shown in FIGS. 2(b) to 2(e) for molded pulp uses “cure-in-the-mold” technology, such that the container 10 or lid 20 is well defined, smooth-surfaced molded pulp products, with a seamless or jointless outer surface and/or inner surface. After being formed, the container 10/lid 20 are captured in the heated mold in which the cellulose with label is pressed and densified. The container 10/lid 20 may therefore be ejected or removed from the mold in a finished state as opposed to being dried in an oven.

The container 10 and/or lid 20 may optionally be fabricated according to a method that may be described as being for forming a container or lid having a cellulose body comprising: blowing cellulose fibers onto a surface of a mold to form a layer of cellulose fibers into the surface of the mold; pressuring the layer of cellulose fibers in the mold, whereby the cellulose is thermoformed into a monoblock piece of interconnected cellulose fibers; and removing the monoblock piece of interconnected cellulose fibers.

The container 10 and/or lid 20 may be said to have a body of molded cellulose, the body of molded cellulose defining at least one wall, the wall having an outer surface and an inner surface. The container or lid has is made of blown cellulose fibers, with a majority (e.g., at least 90% per weight) of the fibers are 2.5-3.5 mm in length, inclusively, when blown to form a mat, the mat then compressed in at least one compression step. In the container or lid, before compression, the water content may be said to be from 5-15% per weight, inclusively.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A container or lid comprising:
a body of molded cellulose, the body of molded cellulose defining
at least one wall, the wall having an outer surface and an inner surface,
wherein the container or lid has is made of blown cellulose fibers from a mat compressed in at least one compression step.

2. The container or lid according to claim 1, wherein the container or lid is seamless and/or jointless.

3. The container or lid according to claim 1, wherein the at least one wall has a thickness of 0.3 mm to 0.6 mm inclusively.

4. The container or lid according to claim 1, wherein the body defines an inner cavity.

5. The container or lid according to claim 4, wherein a surface of the inner cavity has a coating thereon.

6. The container or lid according to claim 5, wherein the coating is a waterproofing coating.

7. The container or lid according to claim 1, wherein the at least one wall has at least two layers of the blown cellulose fibers.

8. The container or lid according to claim 7, wherein one of the at least two layers is a hydrophobic layer.

9. The container or lid according to claim 8, wherein the hydrophobic layer defines an interior surface of the container or lid.

10. The container or lid according to claim 7, wherein one of the at least two layers is a lipophobic layer.

11. The container or lid according to claim 10, wherein the lipophobic layer defines an exterior surface of the container or lid.

12. A method for forming a container having a cellulose body comprising:
blowing cellulose fibers onto a surface of a mold to form a layer of cellulose fibers into the surface of the mold;
pressing the layer of cellulose fibers in the mold, whereby the cellulose is thermoformed into a monoblock piece of interconnected cellulose fibers; and
removing the monoblock piece of interconnected cellulose fibers.

13. The method according to claim 12, wherein blowing cellulose fibers includes blowing softwood fibers.

14. The method according to claim 12, wherein blowing cellulose fibers includes blowing cellulose fibers having a length between 2.5-3.5 mm, inclusively.

15. The method according to claim 12, wherein pressing the layer of cellulose fibers includes heating the layer of cellulose fibers.

16. The method according to claim 12, wherein blowing cellulose fibers onto the surface of the mold to form the layer including forming the layer having a thickness of 4-6 mm.

17. The method according to claim 16, wherein pressing the layer of cellulose fibers into the monoblock includes pressing the layer of cellulose fivers into the monoblock having a thickness between 1-3 mm.

18. The method according to claim 12, further including repeating the pressuring and the removing with another mold, using the monoblock piece.

19. The method according to claim 12, including shredding raw material into the cellulose fibers.

20. The method according to claim 19, including humidifying the raw material prior to the shredding.
